(19) United States
(12) Patent Application Publication
(10) Pub. No.: US 2015/0046060 A1
(43) Pub. Date: Feb. 12, 2015

(54) Method and System for Adjusting Vehicle Settings

(71) Applicant: Mitsubishi Electric Research Laboratories, Inc., Cambridge, MA (US)

(72) Inventors: Daniel Nikolaev Nikovski, Brookline, MA (US); Michael Jones, Belmont, MA (US)

(73) Assignee: Mitsubishi Electric Research Laboratories, Inc., Cambridge, MA (US)

(21) Appl. No.: 13/964,160

(22) Filed: Aug. 12, 2013

(51) Int. Cl. B60R 16/037

(52) U.S. Cl. CPC B60R 16/037
USPC 701/99; 701/1

(57) ABSTRACT

Settings in a vehicle are adjusted by first learning a predictive model of output vectors that correspond to input vectors of sensor data acquired from vehicle subsystems during training. Each input vector defines a known context associated with the vehicle. During later operation of the vehicle, additional input vectors are obtained from the subsystems, and the corresponding output vectors to adjust the settings are then determined using the predictive model.

### FIELD OF THE INVENTION

The invention relates generally to automatic customization of adjustable settings in a vehicle, and more particularly to adjusting the setting to maximize passenger corn fort and minimize driver distraction.

### BACKGROUND OF THE INVENTION

Modern vehicles allow the customization and personalization of vehicle setting to improve the comfort of the driver and passengers. For example, vehicles can include seals with adjustable height, position, inclination, and temperature, adjustable outside and inside rear-view mirrors, infotainment consoles, air conditioning system with adjustable temperature, fan speed, and air directions for multiple vents (climate control system), and the like.

Although the customization can maximize rider comfort, it is often the case that multiple users can regularly drive the same vehicle at different times, the users could prefer very different positions for these variable settings. Most frequently, this occurs when the use of the vehicle is shared on a regular basis. Often, each user would find the settings selected by other users uncomfortable, particularly when “neutral” settings are pre-selected at vehicle startup, and the current user is compelled to adjust the preferences and settings. Iii addition to being inconvenient and time consuming, the adjustment can also be very dangerous when the vehicle is in motion, either because the driver did not notice that the settings were wrong, or the driver is attempting to save time or adjust the setting to current driving and traffic conditions, or other conditions such as the outside temperature.

One possible solution to this problem is to recognize an identity of the driver, and associate sets of settings with specific drivers. One possible means to recognize the identity of the driver is to embed an identification (ID) in vehicle keys, and use a different key for each driver. U.S. Pat. No. 6,198,996 describes a method for recognizing the identity of the driver by means of a smart card key that is used for authorization and storing the preferred performance and ride parameters for the user associated with the card.

U.S. Pat. No. 4,920,338 describes a method for automatic seat positioning based on a set of different ignition keys that store the preferred seat position for each user of the key.

Biometrics can also be used to recognize the identity of the driver, The biometrics can be based on face, fingerprint, or retina recognition methods. U.S. Pat. No. 6,810,309 describes a method for driver identification by means of face recognition from images acquired by a camera in the vehicle. U.S. Pat. No. 5,686,765 describes a vehicle security system that uses fingerprint and retina scanners. U.S. Pat. No. 8,344,849 describes a method for driver identity verification based on a multimodal algorithm that uses several biometric techniques. U.S. Patent Publication 20080228358 describes a vehicle personalization system based on data indicative of physical characteristics of a user. The advantage of those methods is that the driver does not need to carry any special devices to be recognized.

However, both the key-based and biometric methods for driver identifications have notable disadvantages. The first disadvantage is the need for specialized equipment, such as smart card keys, cameras, fingerprint and retina scanners, etc., as well as systems to produce these. The second disadvantage arises from the assumption that knowing the identity of the driver is sufficient for personalizing the vehicle settings. This would be true if the only person in the vehicle that needed customized settings is the driver. However, that is often not the case. For example, the cabin temperature is based on the preferences of all passengers, and not only on the driver. Radio station presets are also equally likely to be used by passenger as by the driver.

Although it is possible to recognize multiple identities of vehicle occupants, for example, by means of dedicated ID badges or biometric recognition at all seats, such a recognition is likely to be cumbersome and/or prohibitively expensive in comparison to the convenience provided by personalization.

### SUMMARY OF THE INVENTION

The embodiments of the invention provide a method and system for dynamically adjusting settings ala vehicle, without the need for complicated and expensive identification of the driver and other occupants in the vehicle.

The system acquires sensor data from subsystems of the vehicle, such as an engine control unit (ECU) and a vehicle navigation system, and associates the sensor data with known settings. Correct associations are established by means of machine learning procedure (MLP) operating on suitable representations of a current operating context. After a reliable predictive model has been constructed, the model is periodically used to predict the correct settings for the current context, and if they differ from the current settings, adjustments are initiated automatically. The model can be updated over time, or on demand.

### BRIEF DESCRIPTION OF THE DRAWINGS

FIG. 1 is a block diagram of a system and method for a method and system for customizing and adjusting settings in a vehicle according to embodiments of the invention; and

FIG. 2 is a block diagram of a training phase according to embodiments of the invention.

### DETAILED DESCRIPTION OF THE PREFERRED EMBODIMENTS

The embodiments of the invention provide a method and system for automatic customizing and adjusting settings in a vehicle. The invention addresses the problem of vehicle settings personalization without the need for complicated and expensive identification of the driver and other occupants in the vehicle. The invention is based on the idea that at any given moment, the preferred settings are not specific for the current driver, but rather to a current context. Recognition of the context is possible from the sensor data acquired from operational subsystems of the vehicle during routine operation of the vehicle. In the preferred embodiment, the method and system do not require any additional sensors or identification devices in the vehicle, other than the ones already installed, although specialized sensors could be used if desired. Also, the identity of the occupants does not need to be explicitly known.

Context

As defined herein, a context is a set of situations that are not identical, but are characterized by some operating commonality. An example of a context is the commute to or from work or school by the vehicle operator, or perhaps another occupant. In this case, the commonality is the time of day (morning) and type of day (work/school day), regardless of what other variations exist, such as outdoor temperature, travel time, etc. A set of preferred settings can be associated with this context and assumed user of the vehicle during this context.

Another example is the context when both the driver and passenger seat are occupied. In this case, the set of preferred settings associated with this context corresponds to the settings that are comfortable for both occupants, for example, a “neutral” temperature. Note that these settings can be different from those in either set of preferred settings for the two separate contexts when only one occupant is in the vehicle.

The concept of a vehicle context subsumes the approaches to vehicle personalization based on driver identification because the identity of the driver can also be the commonality that defines the context. For example, the set of situations when driver A is operating the vehicle can defines a context, and similarly the set of situations when driver B is operating the vehicle defines another context. However, in our approach, contexts are not distinguished h driver as in the prior art, by rather by meaningful commonality in the sensor data.

Thus, we reduce the problem of vehicle personalization not to the task of driver and/or passenger identification, but to the task of association between contexts defined by the sensor data for the preferred settings. The main problem in this task lies in recognizing contexts that are predictive of the known variations in preferred settings.

Method System Overview

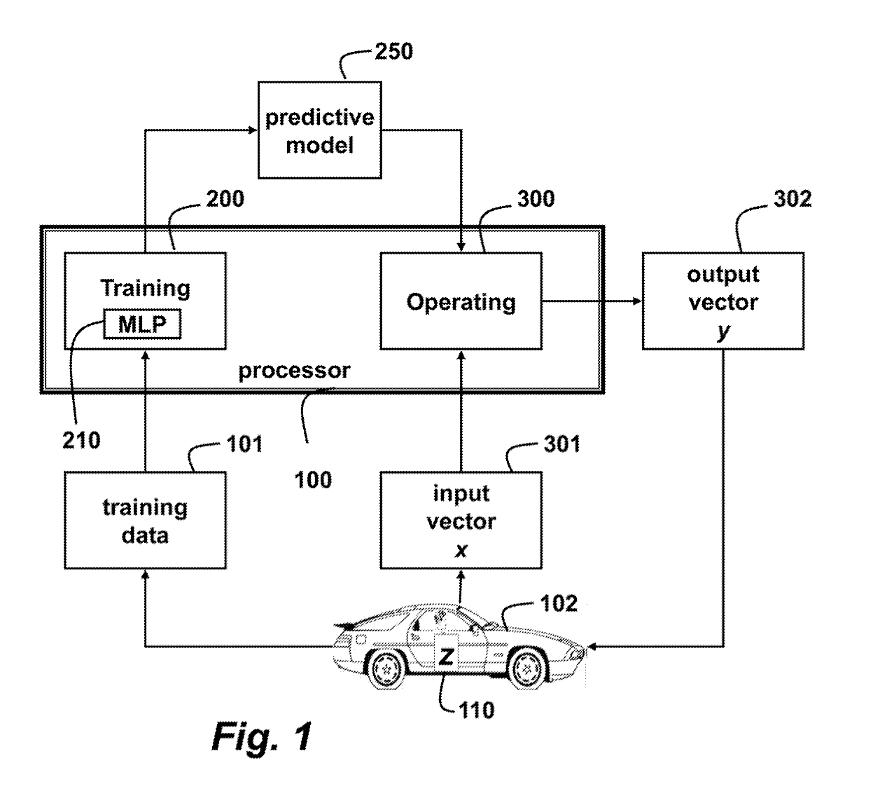

As shown in FIG. 1, the method and system include training phase 200 and an operating, phase 300. The training can be one time, periodic, continuous, or on demand. During the training, training sensor data 101 are acquired from subsystems (see below) in a vehicle 102. The training data include pairs of observed input vectors 301 and observed output vectors 103. The input vectors define the current context. The output vectors define the current settings for the devices that could be adjusted. The training data are used to construct a predictive model 250 using a machine learning procedure (MLP) 210. The purpose of the MLP is to establish a causal relationship between the input vectors (context) and output vectors (settings corresponding to this context).

During operation 300, input vectors x 301 of sensor data are periodically constructed, identically to the training phase. During operation, the correct output vector for the current context is not known, and it is the objective of the prediction method to determine the correct output, using the predictive model 250. The input vectors 301 can be obtained from sensor data acquired from the subsystems during normal operation of the vehicle. The sensor data are time series, as described below. The predictive model is then used to generate corresponding output vectors y_{pred} 302, which in turn automatically adjust the vehicle settings z 110 depending on the current context.

The steps of the method can be performed in a processor 100 connected to a memory 109 and input/output interfaces as known in the art. The interfaces can connect to the buses described herein.

Training

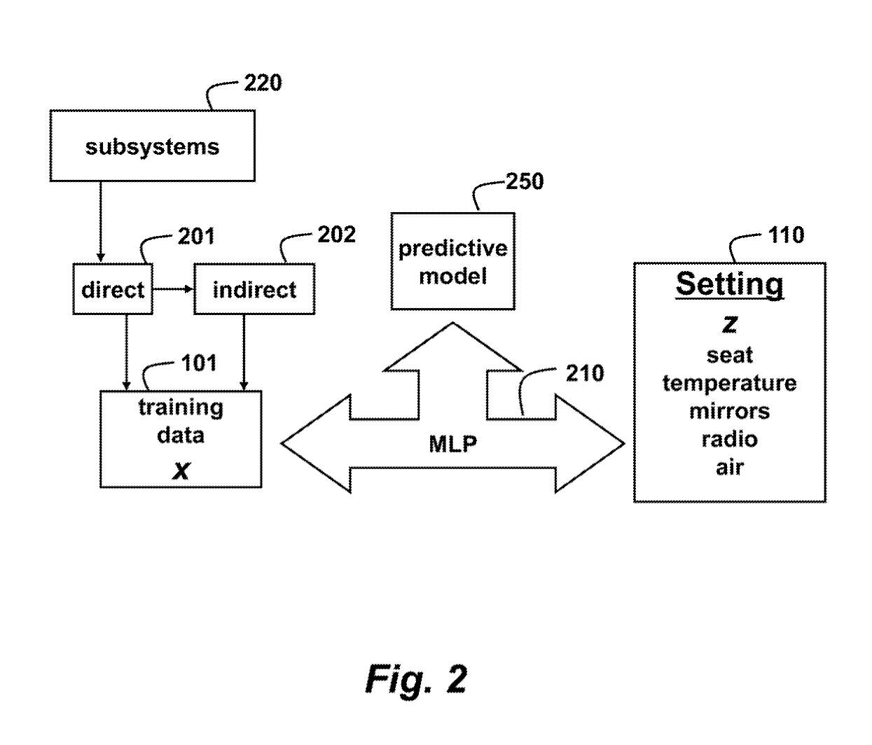

As shown in FIG. 2, the MLP 210 can discover hidden relationships between the input vectors x the output vectors y, and the settings z The sensor data are organized into a training set of M examples, where each example is a pair (x^{(k)}, y^{(k)}), for k=1, . . . , M. The input vector x=[x₁, x₂, . . . , x_{N}] has N components that can be sensor data directly 201 measured from the vehicle subsystems 220, or derived indirectly 202 by means of expressions, function or extraction procedures, as described below. The output vector y=[y₁,y₂, . . . ,y_{P}] has P components that are related to, but do not necessarily coincide with the independently adjustable settings zᵢ, i=1, . . . , L of the subsystems.

Sensor data that can be used in the construction of the input vectors can include, but is not limited to variables from an engine control unit (ECU), vehicle acceleration, braking force, engine revolutions per minute (rpm), fuel efficiency, battery charge, etc. and from the devices connected to a controller area network (CAN) bus. The CAN bus is a vehicle bus standard designed to allow microcontrollers and devices to communicate with each other without a host computer. The CAN bus is particularly useful in modern vehicles that perhaps have about a hundred electronic control units (ECU) for the various subsystems, such as the engine control unit, the power train control module, units for controlling the transmission, airbags, antilock braking, cruise control, electric power steering, audio systems, windows, doors, mirror adjustment, battery and recharging systems for hybrid or electric cars, fuel systems, cabin temperature, passenger seat occupancy indicator, vehicle navigation unit that can indicate time, date, speed, direction, destination, estimated time of arrival, and infotainment systems, etc.

The indirect data 202 can include, but is not limited to: type of day (workday vs. weekend), day of the week, period during the day (morning, afternoon, evening, night), etc.

The adjustable settings z 110 can include, but is not limited to: seats height, position, inclination, and temperature; rear-view mirror position (in-cabin, left, and right mirrors); radio station presets; air conditioning system temperature set-point (driver and passenger sides, if available separately), fan speed, air directions for all vents, etc.

There are several ways to construct the input vectors and generate the output vectors x and y during training and operation. One method for constructing the input vector x includes the direct data 201 and the indirect data 202. This method can be very effective in recognizing contexts that depend on one or more of these variables. For example, if one user only drives the vehicle on weekdays, and another only drives the vehicle on weekends, the input vector constructed in this way has all the information necessary to distinguish between the two contexts relevant for personalization. In this case, the derived datum is, e.g., type of day. Other non-overlapping time sharing between two or more users can also be handled with this type of input vector.

More complicated context recognition can be implemented by extending the range of data considered for inclusion in the input vector, so that the most recent sensor data and data from a longer time period preceding the current time are used, for example from the time the vehicle was started, has been in motion for a while until the current time. This latter condition assumes that the driver is the same, and positions of other occupants have not changed. The availability of this data can capture a much wider range of possible contexts, for example contexts defined by the driving style of the current driver, as described, by the acceleration and braking patterns, as well as specific sequences of actions that the driver initiates. For example, one driver might always start the engine, and then buckle the seat belt, while the other driver performs these two tasks in a reverse order. By noting the difference in the order of the actions, the association procedure is able to distinguish between the two drivers and their contexts.

If a larger set of sensor data is used, the problem becomes one of association between a high-dimensional time series and the current settings. The practical consideration now is how to handle the large data set data in a time series. Including all of that data into the input vector x is not possible, because x has a constant dimensionality, whereas the time series data it with time One possibility is to limit the duration of the time series. But even in this case, the size of x increases quickly, and reliable estimation of the relationship between x and the output vector y would requite an unreasonably amount of training data.

One possible way to address this problem is to search for a limited number of short sub-sequences in the entire high-dimensional time series, with the property that these subsequences are highly predictive of the output vector.

Such subsequences are known as motifs or shapelets, and can be discovered in the entire set, of time series by means of computationally efficient. procedures. During the training, a search procedure analyzes the entire time series to detect highly predictive subsequences (HPS), and constructs a Boolean indicator variable xᵢ for each of subsequence. The input vector augmented by indicator variables at the HPS constitutes a concise input representation.

One method includes all variables that are relevant to the adjustable setting in the output vector, such that the value of output variable yᵢ is equal to the value of the adjustable setting zᵢ: yᵢ=zᵢ, for example the angle of the left rear view mirror. This type of output variable can be used with the first type of input features described above, where no previous data are used or available. This type of output variable typically is used for discovering of then UPS when all output variables are discrete (Boolean or multinomial).

Another possibility identifies the settings that correspond to individual users by means of a quantization procedure, for example a clustering procedure. In that case, the output variable yᵢ takes on discrete values that correspond to the cluster identified during the clustering phase. In most cases, one cluster corresponds to only one user, and describes the general intervals of values that the user selects for the adjustable settings. The output representation is necessarily discrete in nature (Boolean or multinomial), and can be used with both types of input representations.

After the database of training examples pair (x^{(k)}, y^{(k)}, k=1, . . . , M has been constructed, the mapping between input and output variables can be identified by the MLP 210, e.g., neural networks, support vector machines, k-nearest neighbors, Gaussian mixture models, Bayes models, decision trees, probabilistic graphical models, and radial basis function classifiers.

To personalize the settings, the method uses the predictive model obtained from the training and available sensor data at regular intervals, for example every minute. The input vectors x are constructed identically to the way the input vectors are constructed during training. The method can then produce a most likely output vector y_{pred}. After that, the settings zᵢ are adjusted to correspond to the context associated with the output vector y_{pred}.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for adjusting settings in a vehicle, comprising the steps of training and operating,
wherein the training further comprises:
constructing input vectors from sensor data acquired from vehicle subsystems, wherein each input vector defines a context;
constructing, for each input vector, a corresponding output vector from adjustable settings recorded in a current context;
accumulating, in a memory, a training database including pairs of the input vectors and the output vectors;
learning a predictive model from the training database, wherein the predictive model predicts the corresponding output vector from the input vector; and
wherein, the operating further comprises:
constructing the input vectors from sensor data acquired from vehicle subsystems that defines the contexts;
predicting a most likely output vector using the predictive model; and
adjusting the settings according to the most likely output vector, wherein the method is performed in a processor.

2. The method of claim 1, wherein the input vectors consists of currently measurable variables.

3. The method of claim 1, wherein the input vectors consists of currently measurable variables and past measured variable.

4. The method of claim 1, wherein the most likely output vector encodes directly real-valued adjustable settings.

5. The method of claim 4, wherein the most likely output vector consists of discrete cluster identifications, and where a clustering procedure is applied to the real-valued adjustable settings.

6. The method of claim 1, wherein the predictive model is represented by neural networks, vector support machine, decision tree, or a probabilistic graphical model.

7. The method of claim 1, wherein the subsystems include an engine control unit, a vehicle navigation system, and a climate control system.

8. The method of claim 1, wherein the context is an operating commonality.

9. The method of claim 1, wherein the training is one time, periodic, continuous, or on demand.

10. The method of claim 1, wherein the learning discovers hidden relationships between the input vectors and the output vectors, and the settings.

11. The method of claim 1, wherein the sensor data are time series data, and further comprising:
searching for a limited number of short subsequences in the time series with a property that the subsequences are highly predictive of the most likely output vector.

12. The method of claim 11, wherein the subsequences are motifs or shapelets.

13. The method of claim 1, wherein the most likely output vector takes on discrete values.
